(19) United States
(12) Patent Application Publication
(10) Pub. No.: US 2021/0154690 A1
(43) Pub. Date: May 27, 2021

(54) GYRATION DEVICE FOR SPRAY GUN

(71) Applicant: HUI BAO ENTERPRISE CO., LTD., CHANGHUA COUNTY (TW)

(72) Inventor: WAN PAO CHEN, CHANGHUA COUNTY (TW)

(21) Appl. No.: 16/711,903

(22) Filed: Dec. 12, 2019

(30) Foreign Application Priority Data
Nov. 22, 2019 (TW) 108215513

(51) Int. Cl. B05B 3/00; B05B 7/12; B05B 7/00

(52) U.S. Cl. CPC B05B 3/008; B05B 7/0075; B05B 7/12

(57) ABSTRACT

A spray gun includes a barrel having a path between an entrance and an outlet. A guide member is connected to the outlet. A rotary member has a tapered way defined therein, and a Venturi tube is partially located in the tapered way. A spray head is connected to the front end of the barrel and has an orifice defined in the spray head. A room is formed by the guide member and the spray head. The rotary member is located in the room. Pressurized liquid passes through the path and enters into the room to rotate the rotary member, and the detergent is sucked by the Venturi tube and spread out from the orifice in a rotational pattern.

### BACKGROUND OF THE INVENTION

### 1. Fields of the Invention

The present invention relates to a spray gun, and more particularly, to a gyration device for a spray gun.

### 2. Descriptions of Related Art

One of conventional spray guns known to applicant is disclosed in FIG. 13, and includes an expanded nozzle head 8 and a Venturi tube 7 is located within the expanded nozzle head 8. When high pressurized air is introduced into the spray gun, the detergent in the container that is connected to the spray gun is sucked and sprayed from the outlet 71 of the Venturi tube 7. The Venturi tube 7 has a free end that includes an outlet and the free end of the Venturi tube 7 randomly swings so as to spray the detergent to the surface or object to be cleaned. However, there will be a blind area 9 where the detergent cannot reach due to the swinging mold that the Venturi tube 7 acts.

U.S. Pat. No. 9,751,098B1 uses a bearing installed to the outlet 71 of the Venturi tube 7 so as to control the swinging mold and reduces the blind area 9. This increases the manufacturing cost. Besides, the container for the spray gun is fixed and cannot be used in a narrow space.

The present invention is intended to provide a gyration device for a spray gun that is designed to eliminate the drawbacks mentioned above.

### SUMMARY OF THE INVENTION

The present invention relates to a spray gun and comprises a barrel having a grip formed to the rear end thereof. An entrance is formed in the grip. An outlet is formed in the front end of the barrel. A path is defined through the barrel and communicates with the entrance and the outlet. A guide member is connected to the outlet of the barrel and has a tubular portion protruding from the front end thereof. A lateral hole is defined through the wall of the guide member and communicates with the path. A rotary member has a tapered way defined therein. A Venturi tube is partially located in the tapered way. The first end of the Venturi tube is located close to the outlet. A ball head is formed to the front end of the rotary member.

A spray head is connected to the front end of the barrel and has an orifice. A ball socket is defined in the inner wall of the orifice. A room is formed by the guide member and the spray head. The rotary member is located in the room, and the ball head of the rotary member is rotatably accommodated in the ball socket of the spray head. The tapered way of the rotary member is mounted to the tubular portion of the guide member. A first support point is formed between the ball head of the rotary member and the ball socket of the spray head. A second support point is formed between the tubular portion of the guide member and the inner wall of the tapered way.

Pressurized liquid passes through the path and enters into the room via the lateral hole to form a first force that is applied to the outer surface of the rotary member to rotate the rotary member about the ball head of the rotary member rotatably accommodated in the ball socket of the spray head. The pressurized liquid enters into the tapered way from a gap between the rear end of the rotary member and the tubular portion of the guide member to form a second force. The second force swings the rotary member within the room. The first force is larger than the second force to keep rotating the rotary member.

Preferably, the rotary member includes multiple flanges extending from the outer surface of the rotary member.

Preferably, the barrel includes a connection tube which communicates with the middle portion of the path. A control valve is connected between the connection tube and a container. The second end of the Venturi tube is inserted into the container. A trigger is connected to the spray gun and located between the entrance and the connection tube.

Preferably, the barrel rotatably extends through a pivotal seat. The pivotal seat includes a three-way member and two seals. The three-way member includes a first way and a second way which is perpendicular to the first way. The two seals are mounted to the barrel and located on two ends of first way. The second way is defined through an insertion portion of the three-way member, and the insertion portion is connected to the connection tube so that the container is pivotable about an axis of the path. A control valve is connected to the connection tube.

Preferably, a throttle valve is connected to the grip.

Preferably, the spray head has an expanded nozzle head.

Preferably, the spray head is integral with a blowing tube which has an expanded head. A stand is pivotably connected to a connection bar formed on the barrel. The blowing tube is connected to the stand.

Preferably, the stand is made by bending a wire and includes two distal ends which are inserted into two end holes formed to two ends of the connection bar. The blowing tube includes a grooved surface, and the stand is wrapped to the grooved surface.

The advantages of the present invention are that gyration device of the present invention allows the spray gun to spread detergent or liquid evenly on a large area, and the container is pivotable so as to be used in a narrow space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the spray gun with the gyration device of the present invention;

FIG. 2 is an exploded view of the gyration device of the present invention;

FIG. 3 is a cross sectional view to show the spray gun with the gyration device of the present invention;

FIG. 4 is an enlarged and cross sectional view to show the gyration device of the present invention;

FIG. 5 shows that the rotary member is rotated to another position;

FIG. 6 is an end cross sectional view, taken along line a-a of FIG. 4;

FIG. 7 is an exploded view of the pivotal seat of the gyration device of the present invention;

FIG. 8 shows that the container is pivoted about the path of the barrel;

FIG. 9 shows the blowing tube to be attached to the spray gun with the gyration device of the present invention;

FIG. 10 is a cross sectional view to show the operation of the spray gun with the blowing tube attached to the spray gun with the gyration device of the present invention;

FIG. 11 shows the foam generator to be attached to the spray gun with the gyration device of the present invention;

FIG. 12 shows a cross sectional view of the foam generator attached to the spray gun with the gyration device of the present invention, and

FIG. 13 shows a portion of a conventional spread gun.

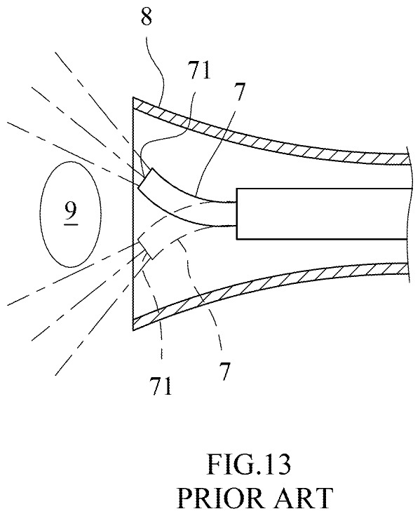

### DETAILED DESCRIPTION OF THE PREFERRED EMBODIMENT

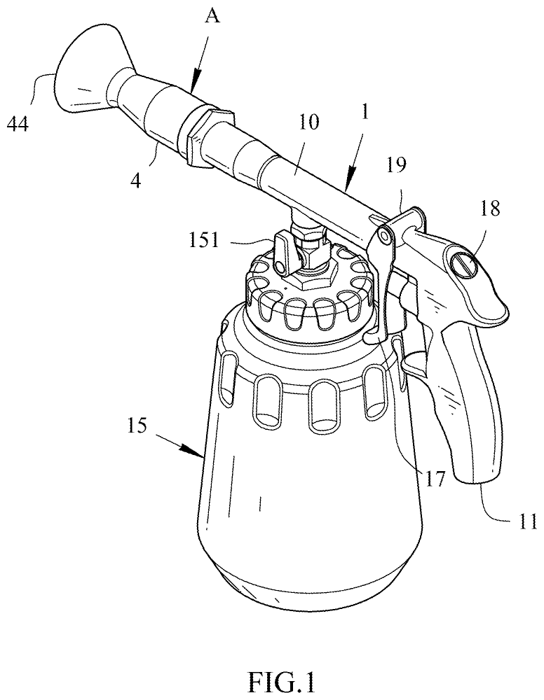

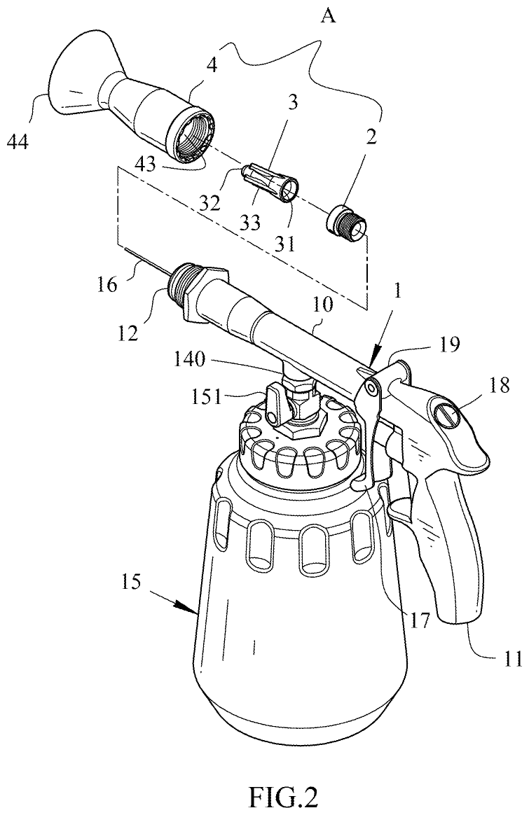

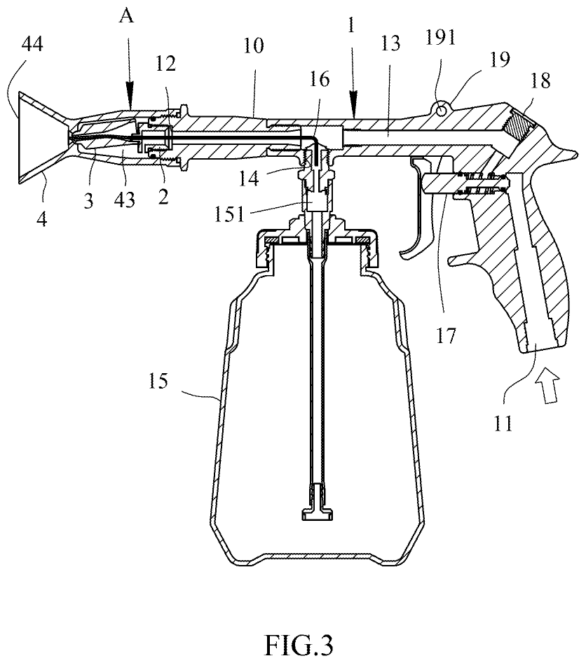

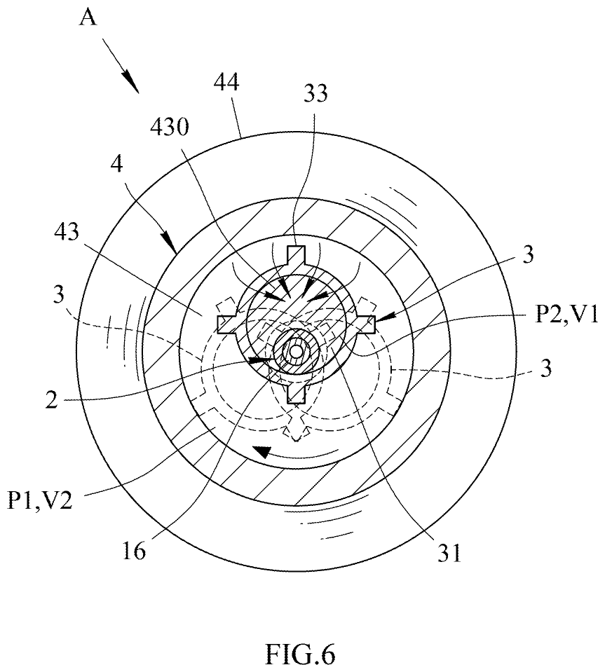

Referring to FIGS. 1 to 6, the spray gun 1 of the present invention comprises a barrel 10 having a grip 11 formed to the rear end thereof, and an entrance 11 is formed in the bottom of the grip 11 so as to be connected with an air compressor (not shown) to introduce pressurized air into the spray gun 1. An outlet 12 is formed in the front end of the barrel 10. A path 13 is defined through the barrel 10 and communicates with the entrance 11 and the outlet 12. A gyration device “A” is connected to the front end of the barrel 10. The barrel 10 includes a connection tube 140 which is formed to the middle portion of the barrel 10 and communicates with the middle portion of the path 13. A control valve 151 is connected between the connection tube 140 and a container 15. Detergent or water is received in the container 15. A trigger 17 is connected to the spray gun 1 and located between the entrance 11 and the connection tube 140. A throttle valve 18 is connected to the grip 11 so regulate the volume of pressurized air introduced in the path 13.

The gyration device “A” comprises a guide member 2 that is connected to the outlet 12 of the barrel 10 and has a tubular portion 21 protruding from the front end thereof. A lateral hole 22 is defined through the wall of the guide member 2 and communicates with the path 13. A rotary member 3 has a tapered way 31 defined therein. A Venturi tube 16 is partially located in the tapered way 31, and the first end of the Venturi tube 16 located close to the outlet 12, and the second end of the Venturi tube 16 is inserted into the container 15. A ball head 32 is formed to the front end of the rotary member 3.

A spray head 4 is connected to the front end of the barrel 10 and has an expanded nozzle head 44. An orifice 41 defined through the inner end of the expanded nozzle head 44 of the spray head 4. A ball socket 42 is defined in the inner wall of the orifice 41. A room 43 is formed by the guide member 2 and the spray head 4. The rotary member 3 is located in the room 43. The ball head 32 of the rotary member 3 is rotatably accommodated in the ball socket 42 of the spray head 4. The tapered way 31 of the rotary member 3 has an interior space V1, and the room 43 has an interior space V2 which is larger than V1. The Venturi tube 16 extends through the outlet 12 and the guide member 2, and is located in the tapered way 31. The rotary member 3 includes multiple flanges 33 extending from the outer surface of the rotary member 3.

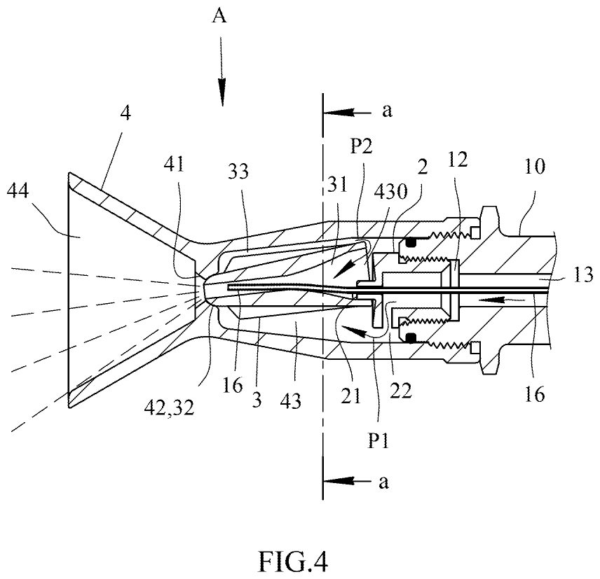

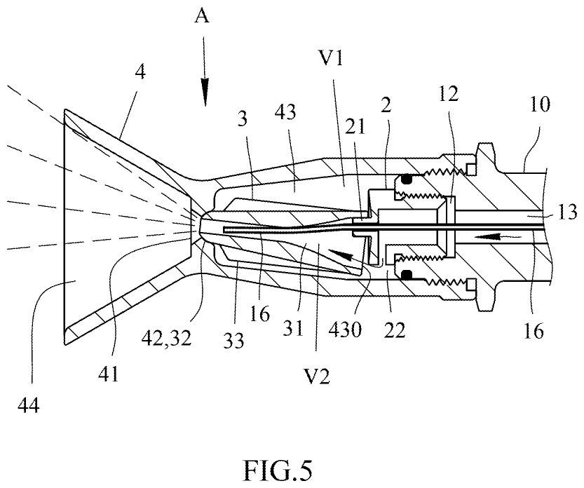

As shown in FIGS. 4 and 5, the tapered way 31 of the rotary member 3 is larger than the tubular portion 21 of the guide member 2. In other words, the tubular portion 21 of the guide member 2 is inserted into the tapered way 31 of the rotary member 3, and the rear end of the rotary member 3 can swing while the tubular portion 21 of the guide member 2 is located within the tapered way 31. The ball head 32 of the rotary member 3 is rotatably received in the ball socket 42 of the spray head 4. Therefore, the ball head 32 of the rotary member 3 is rotatably within in the ball socket 42 of the spray head 4. Pressurized liquid passes through the path 13 and enters into the room 43 via the lateral hole 22 to form a first force P1 that is applied to the flanges 33 on the outer surface of the rotary member 3 to rotate the rotary member 3 about the ball head 32 of the rotary member 3 rotatably accommodated in the ball socket 42 of the spray head 4. The pressurized liquid also enters into the tapered way 31 from a gap 430 between the rear end of the rotary member 3 and the tubular portion 21 of the guide member 2 to form a second force P2. The second force P2 swings the rotary member 3 within the room 43. The first force P1 is larger than the second force P2 to keep rotating the rotary member 3. The tubular portion 21 of the guide member 2 will contact the inner wall of the tapered way 31 to control the rotary member 3 to rotate within a desired range. The rotary member 3 does not move in the axial direction thereof. The detergent or water in the container 15 is sucked by the Venturi tube 16 and is spread out from the Venturi tube 16 in the rotary member 3. By the rotation of the rotary member 3, the detergent or water is evenly spread via the orifice 41 to a large area without blind areas.

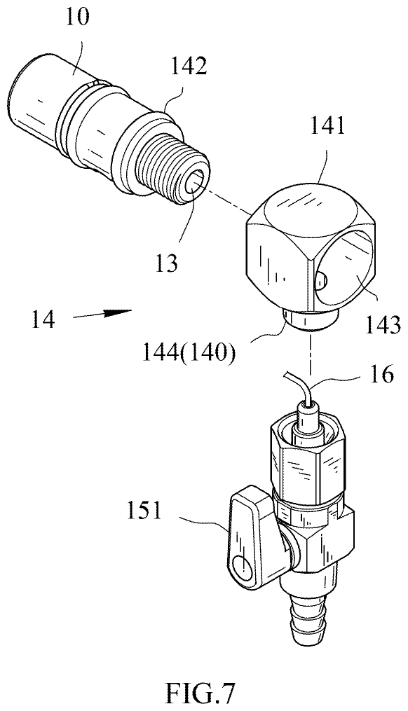

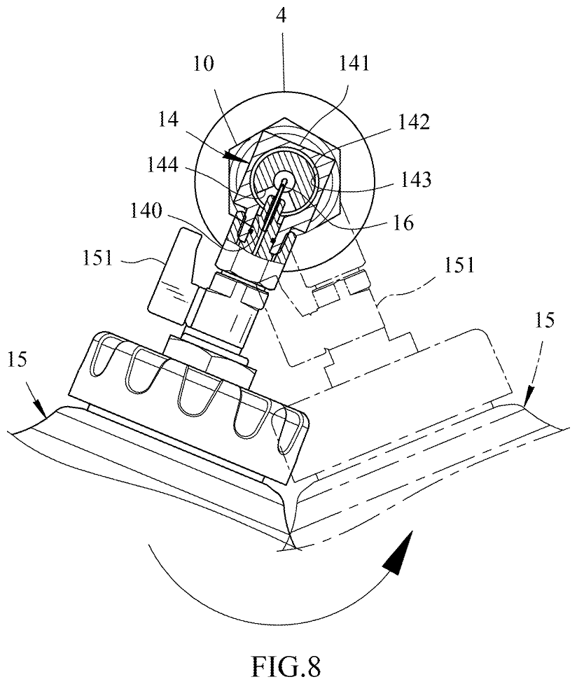

As shown in FIGS. 7, 8 and 12, the barrel 10 rotatably extends through a pivotal seat 14 that is located at the connection tube 140. The pivotal seat 14 includes a three-way member 141 and two seals 142. The three-way member 141 includes a first way 143 and a second way 144 which is perpendicular to the first way 143. The two seals 142 are mounted to the barrel 10 and located on two ends of first way 143 to form sealing feature. The second way 144 is defined through an insertion portion of the three-way member 141, and the insertion portion is connected to the connection tube 140 so that the container 15 is pivotable about the axis of the path 13. A control valve 151 is connected to the connection tube 140.

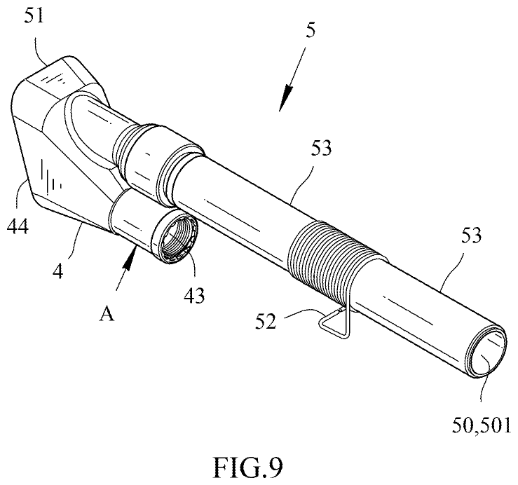

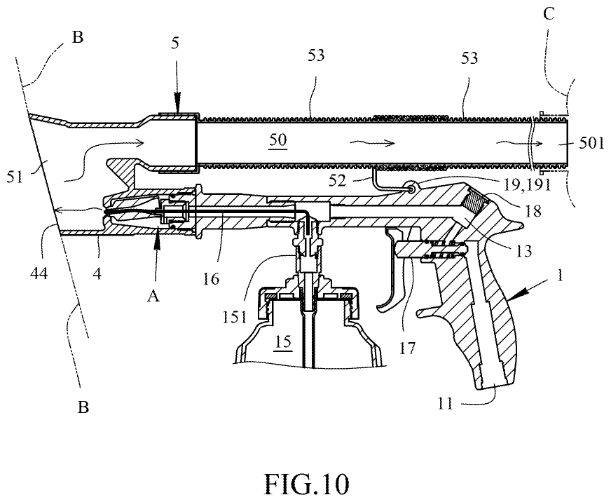

As shown in FIGS. 9 and 10, in this embodiment, the spray head 4 is integral with a blowing tube 5 which has an expanded head 51. An air-way 50 is defined axially through the blowing tube 5, and an opened 501 is defined in the rear end of the blowing tube 5. A dust bag “C” is connected to the open end 501. A stand 52 is pivotably connected to a connection bar 19 formed on the barrel 10. The stand 52 is made by bending a wire and includes two distal ends which are inserted into two end holes 191 formed to two ends of the connection bar 19. The blowing tube 5 includes a grooved surface 53, and the stand 52 is wrapped to the grooved surface 53 of the blowing tube 5. The expanded bozzle head 44 of the spray head 4 and the front open end of the blowing tube 5 are combined to form an expanded open end 51. The expanded open end 51 is contact against a wall with dirty surface “B”, the control valve 151 of the contain r15 is turned off, when pulling the trigger 17, the pressurized air blows off the dust from the dirty surface “B”, and the dust flows backward via the air-way 50 and is collected in the dust bag “C”.

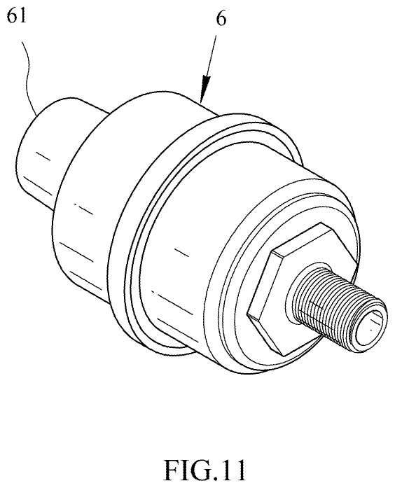

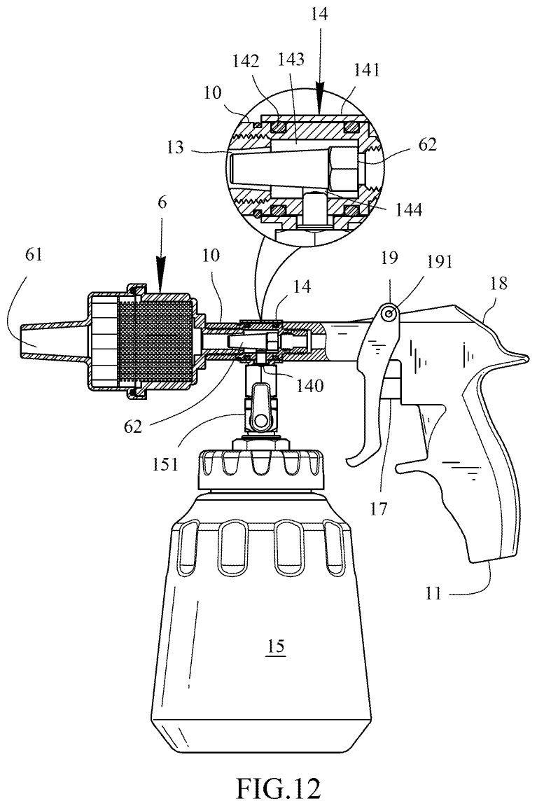

In another embodiment, as shown in FIGS. 11 and 12, a foam generator 6 is connected to the front end of the barrel 10 while the Venturi tube 16 is removed from the spray gun 1 and a suction member 62 is installed in the barrel 10. When the pressurized air passes through the pivotal seat 14, the suction member 62 sucks the detergent or water from the container 15 into the path 13. The foam generator 6 treats the mixture of the pressurized air and the detergent or water to generate foams and bubbles which is spread out from the outlet 61 of the foam generator 6.

While we have shown and described the embodiment in accordance with the present invention, it should be clear to those skilled in the art that further embodiments may be made without departing from the scope of the present invention.

What is claimed is:

1. A spray gun, comprising:
a barrel having a grip formed to a rear end thereof, an entrance formed in the grip, an outlet formed in a front end of the barrel, a path defined through the barrel and communicating with the entrance and the outlet;
a guide member connected to the outlet of the barrel and having a tubular portion protruding from a front end thereof, a lateral hole defined through a wall of the guide member and communicating with the path;
a rotary member having a tapered way defined therein, a Venturi tube partially located in the tapered way, a first end of the Venturi tube located close to the outlet, a ball head formed to a front end of the rotary member, and
a spray head connected to the front end of the barrel and having an orifice, a ball socket defined in an inner wall of the orifice, a room formed by the guide member and the spray head, the rotary member located in the room, the ball head of the rotary member rotatably accommodated in the ball socket of the spray head, the tubular portion of the guide member movably located within the tapered way of the rotary member, wherein pressurized liquid passes through the path and enters into the room via the lateral hole to form a first force that is applied to an outer surface of the rotary member to rotate the rotary member about the ball head of the rotary member rotatably accommodated in the ball socket of the spray head, wherein the pressurized liquid enters into the tapered way from a gap between a rear end of the rotary member and the tubular portion of the guide member to form a second force, the second force swings the rotary member within the room, the first force is larger than the second force to keep rotating the rotary member.

2. The spray gun as claimed in claim 1, wherein the rotary member includes multiple flanges extending from the outer surface of the rotary member.

3. The spray gun as claimed in claim 1, wherein the barrel 10 includes a connection tube which communicates with a middle portion of the path, a control valve is connected between the connection tube and a container, a second end of the Venturi tube is inserted into the container, a trigger is connected to the spray gun and located between the entrance and the connection tube.

4. The spray gun as claimed in claim 2, wherein the barrel rotatably extends through a pivotal seat, the pivotal seat includes a three-way member and two seals, the three-way member includes a first way and a second way which is perpendicular to the first way, the two seals are mounted to the barrel and located on two ends of first way, the second way is defined through an insertion portion of the three-way member, and the insertion portion is connected to the connection tube so that the container is pivotable about an axis of the path, a control valve is connected to the connection tube.

5. The spray gun as claimed in claim 3, wherein a throttle valve is connected to the grip.

6. The spray gun as claimed in claim 1, wherein the spray head has an expanded nozzle head.

7. The spray gun as claimed in claim 1, wherein the spray head is integral with a blowing tube which has an expanded head, a stand is pivotably connected to a connection bar formed on the barrel, the blowing tube is connected to the stand.

8. The spray gun as claimed in claim 1, wherein the stand is made by bending a wire and includes two distal ends which are inserted into two end holes formed to two ends of the connection bar, the blowing tube includes a grooved surface, the stand is wrapped to the grooved surface.

9. The spray gun as claimed in claim 1, wherein the tapered way of the rotary member has an interior space, the room has an interior space which is larger than.
